(19) United States
(12) Patent Application Publication
(10) Pub. No.: US 2006/0099363 A1
(43) Pub. Date: May 11, 2006

(54) Catalyzed process for forming coated articles

(75) Inventor: Said Farha, Pleasantville, NY (US)

Correspondence Address: RYNDAK & SURI LLP, 200 W MADISON STREET, SUITE 2100, CHICAGO, IL, 60602, US

(73) Assignee: PepsiCo, Inc.

(21) Appl. No.: 10/983,150

(22) Filed: Nov. 5, 2004

(51) Int. Cl. B32B 27/08; B32B 27/36; B32B 27/34; B32B 27/30; B32B 27/32

(52) U.S. Cl. 428/35.7; 428/411.1; 428/480; 428/523; 428/412; 428/522; 428/474.4; 428/457; 428/426; 427/372.2; 427/402; 427/487

(57) ABSTRACT

Coated articles are formed by applying a first aqueous solution or dispersion of a thermoplastic resin on a surface of an article and at least one IR curing catalyst to form a film, where at least a portion of the first aqueous solution or dispersion is a thermoplastic epoxy resin. The film is exposed to IR radiation in an amount sufficient to at least partially cure the film, and a substantially cured and/or dried thermoplastic epoxy coating is formed.

### BACKGROUND OF THE INVENTION

1. Field of the Invention

The invention is directed to a catalyzed process for making coated articles and to articles made with the process of the invention. In particular, the invention is directed to a coating process in which the coating comprises a curing catalyst that accelerates the curing of the coating by infrared radiation.

2. Related Background Art

Although plastic containers have replaced glass, ceramic, and metal containers in many applications, those materials are still widely used as well in applications where plastic lacks properties required for the application. For example, plastics are now widely used as containers for food and beverages because plastics may be formed into thin, strong, relatively unbreakable, transparent, translucent, or opaque containers, having a large variety of shapes. Plastic containers are also relatively inexpensive, and retain their shapes. However, the high permeability of gases, e.g., oxygen and carbon dioxide, through the plastics approved by the U.S. Food and Drug Administration (“FDA”), such as PET, make the long-term use of such plastics impracticable with oxygen-sensitive food or beverages or carbonated soft drinks. For example, beer typically will develop an unacceptable taste after less than two weeks in a plastic bottle. Thus, although soda and juices are available in plastic bottles, beer is almost invariably sold in glass bottles or metal cans.

However, plastics have advantages that make them attractive alternatives to glass and metal for a variety of articles. Hollow plastic articles, such as containers, e.g., jars and bottles, may be formed into almost any imaginable shape by molding a thermoplastic preform, preferably by injection molding, and blow molding the preform into an article having the desired shape. A variety of plastics have been used for making plastic preforms and containers. However, only those approved by the FDA may be used in applications where the plastic contacts a food or beverage intended for consumption. Thermoplastic resins having FDA approval and widely used in the container industry include polyethylene terephthalate (“PET”) polymers and copolymers. The PET homopolymer is formed by the polycondensation of [bis]-hydroxyethyl terephthalate. The copolymers are copolyesters containing minor amounts of other glycols or diacids, such as isophthalate copolymers.

The manufacture of biaxially oriented PET containers is well known in the art. Biaxially oriented PET containers are light weight and strong, have good resistance to creep and relatively thin walls, and are capable of withstanding the pressures exerted by carbonated beverages without undue distortion over the desired shelf life. However, as with many plastic materials, thin-walled PET containers are somewhat permeable to carbon dioxide and oxygen, and, thus, allow the loss of pressurizing carbon dioxide and ingress of oxygen that can affect the flavor and quality of the contents of a PET container. Because of the gas permeability of PET, the shelf life of a carbonated beverage in a commercial two-liter PET bottle is typically about 12 to 16 weeks before the pressure in the bottle, about 4.5 atmospheres immediately after bottling, drops below an acceptable level. Smaller bottles have a greater surface-to-volume ratio, and, thus, undergo a more rapid loss of pressure that severely restricts shelf life of the product.

To overcome the problem of gas permeability, various gas-barrier coatings and layers for plastic containers have been proposed and/or used. Techniques known in the art for providing a gas-barrier to a preform or container include co-injection, chemical vapor deposition, plasma coating with amorphous carbon and/or SiOₓ, and applying an aqueous dispersion of barrier polymers, such as dispersions of EVOH, dispersions of MXD6, and dispersions of vinylidene chloride with acrylonitrile and/or methyl acrylate, which may also contain units derived from other monomers, such as methyl methacrylate, vinyl chloride, acrylic acid, or itaconic acid.

U.S. Pat. Nos. 6,391,408 and 6,676,883 to Hutchinson et al. disclose applying a layer of barrier material by dip coating, spray coating, flow coating, flame spraying, electrostatic spraying, dipping the polyester article to be coated in a fluidized bed of barrier resin, or overmolding the polyester article with a melt of barrier material. The preferred gas-barrier resins are phenoxy-type thermoplastics and copolyesters of terephthalic acid, isophthalic acid, and at least one diol. Preferably, the coating is applied as an aqueous solution, suspension, and/or dispersion of the coating material, which is then dried and/or cured, preferably by exposure to infrared radiation (“IR”), which produces heating that dries and/or cures the coating. However, the drying/curing process can be time consuming.

As noted above, although plastic containers have replaced glass, ceramic, and metal containers in many applications, those materials are still widely used. Glass, ceramic, and metal offer several advantages for containers. In particular, glass, ceramic, and metal containers provide a substantially impervious barrier to the diffusion of gases, such as carbon dioxide and oxygen, into or out of the container that is not presently available in plastic containers. As with PET, most glass and certain ceramics are at least partially transparent to visible light, thereby allowing the contents to be observed by a consumer, and are also available in a variety of colors that vary from almost totally transparent to opaque.

Transmission in the ultra violet (“UV”) region of the spectrum in transparent containers is a disadvantage in that UV radiation is known to degrade food and beverages. As a result, to reduce the possibility of degradation, beer, with a few exceptions, is typically sold in cans or green or brown bottles. In addition, the painted or tinted surfaces of cans are also subject to bleaching by UV radiation, and plastic containers can degrade from exposure to UV. As solar radiation is the main source of UV in the environment, the longer wavelengths of UV radiation that reach ground level without being absorbed by the atmosphere are the major concern, as exposure to shorter wavelengths is unlikely. Most of the UV radiation that reaches ground level is in the region known as UV-A, and has a wavelength of 320 to 400 nm. Wavelengths less than 320 nm, i.e., the UV-B region of from 290 to 320 nm and the UV-C region of less than 290 nm, are substantially, if not completely absorbed by atmospheric ozone (O₃) and oxygen (O₂). As absorption by atmospheric ozone begins at about 350 nm and gradually increases to peak at about 255 nm, exposure to UV radiation having a wavelength of less than about 320 nm is generally negligible, and, thus, is not a concern. Therefore, an inexpensive coating for glass and other transparent materials that absorbs UV radiation at those wavelengths where exposure is most likely and is readily applied would be desirable.

It is also known that a reduction in the friction between articles on a production line and portions of the line is desirable, as such reduction reduces jamming and energy costs. Glass bottles and containers are often coated with polyethylene to reduce the coefficient of friction of the surface of the glass. However, as polyethylene and glass do not have a high affinity, the surface is typically first etched with an acid, such as hydrofluoric acid (HF), and then sprayed with polyethylene. As HF and similar acids are highly corrosive and poisonous, the etching process is dangerous, and results in waste disposal problems.

Therefore, a process that provides rapidly-cured gas-barrier material coatings to plastic articles and rapidly-cured UV resistant and/or reduced friction coatings to plastic, glass, ceramic, and metal containers without the need to etch the surface of the glass, ceramic, and metal with corrosive materials would be desirable. The present invention provides such a process.

### SUMMARY OF THE INVENTION

The present invention is directed to a process for making coated articles and articles made with the process of the invention. The process comprises applying a first aqueous solution or dispersion of a thermoplastic resin on a surface of an article, where the first aqueous solution or dispersion comprises a thermoplastic epoxy resin and at least one IR curing catalyst, such as a transition metal or transition metal compound or complex, to form a film, exposing the film to IR radiation in an amount sufficient to at least partially cure the film, and forming a substantially cured and/or dried thermoplastic epoxy coating. Preferably, thermoplastic epoxy resin comprises at least one phenoxy resin, more preferably, the phenoxy resin comprises at least one hydroxy-phenoxyether polymer, and, most preferably, the hydroxy-phenoxyether polymer comprises at least one polyhydroxyaminoether copolymer. Preferably, the polyhydroxyaminoether copolymer is polymerized from resorcinol diglycidyl ether, hydroquinone diglycidyl ether, bisphenol A diglycidyl ether, or mixtures thereof.

Preferably, the amount of IR radiation is at least sufficient to completely cure the film. The aqueous solution or dispersion may be applied by any method known in the art, such as brushing, but is preferably applied by at least one of dip, spray, or flow coating. One or more additional coatings may be applied using any material or method known in the art or with the materials and method of the invention. At least one exterior coating layer is preferably cross-linked fully or partially to provide resistance to chemical or mechanical abuse, wherein coatings for PET preforms are preferably partially cross-linked to allow stretching of the preform and the coating during blow-molding, and coatings applied to blow-molded containers and rigid containers may be cross-linked to a higher degree.

Preferably, the solution or dispersion of the thermoplastic epoxy resin comprises at least one acid salt, formed from the reaction of at least one polyhydroxyaminoether with at least one of phosphoric acid, lactic acid, malic acid, citric acid, acetic acid, and glycolic acid. Also, at least one coating of an acrylic, phenoxy, latex, or epoxy coating to the article, which is cross-linked, may be applied as a coating. Preferably, the coating is cross-linked during drying and/or curing.

Preferably, the process of applying any layer using the method of the invention further comprises withdrawing the article from the dip, spray, or flow coating at a rate so as to form a coherent film, and removing any excess material resulting from the dip, spray, or flow coating. The excess material may be removed using any removal method known in the art, but excess material is preferably removed using at least one of rotation, gravity, a wiper, a brush, an air knife, or air flow.

Useful article substrates include polymers, such as polyesters, polyolefins, polycarbonates, polyamides and acrylics, preferably an amorphous and/or semi-crystalline polyethylene terephthalate, such as that used to form a preform. Other useful substrates include glass, ceramic, and metal.

At least one additional coating layer may be dried and/or cured using a drying/curing source selected from the group consisting of infrared heating, forced air, flame curing, gas heaters, UV radiation. During the drying/curing step, the article should be maintained at a temperature less than that at which the article melts or degrades.

Multilayer articles in accordance with the invention comprise a substrate and at least one layer comprising a thermoplastic material and an IR curing catalyst. The IR curing catalyst is preferably a transition metal or a transition metal compound or complex, and is present in an amount of from about 20 to about 150 parts per million (ppm), based on weight of the layer.

Preferably, the multilayer article is a container preform or bottle having a body portion and neck portion, wherein the coating is disposed substantially only on the body portion, and there is substantially no distinction between layers on the bottle or a container formed from the preform, and the article may have at least one inner layer and at least one outer layer on the substrate, where the outer layer comprises an amount of coating material that is less than that of the inner layer.

### BRIEF DESCRIPTION OF THE DRAWINGS

FIG. 1 illustrates an uncoated article for use with the invention in the form of a preform;

FIG. 2 is a cross-sectional illustration of the uncoated preform of FIG. 1;

FIG. 3 is a cross-sectional illustration of an article coated in accordance with the invention;

FIG. 4 is a cross-sectional illustration of a section of the wall portion of a coated article in accordance with the invention;

FIG. 5 is a cross-sectional illustration of an article coated in accordance with the invention;

FIG. 6 is a plan view of the cavity of a blow-molding apparatus during the blow-molding of a preform coated in accordance with the invention;

FIG. 7 is an illustration of a coated container prepared in accordance with the invention;

FIG. 8 is a cross-sectional illustration of the coated container of FIG. 7;

FIG. 9 is a cross-sectional illustration of a multi-layer article made in accordance with the invention;

FIG. 10 is a non-limiting flow diagram of a process in accordance with the invention;

FIG. 11 is a non-limiting flow diagram of a further process in accordance with the invention in which the system comprises a single coating unit;

FIG. 12 is a non-limiting flow diagram of a further process in accordance with the invention in which the system comprises multiple coating units in one integrated system; and

FIG. 13 is a non-limiting flow diagram of a further process in accordance with the invention in which the system comprises multiple coating units in a modular system.

### DETAILED DESCRIPTION OF THE PREFERRED EMBODIMENTS

As used herein, the term “UV protection layer” refers to a layer that increases the overall UV absorption of the article to which it is applied, and, preferably, has a higher UV absorption coefficient than the article substrate. As used herein, the term “substrate” refers to the material used to form the base article that is coated. Also, as used herein, the terms “gas-barrier material” and “gas-barrier resin,” refer to materials that, when used to coat articles, have a lower permeability to oxygen and carbon dioxide than the article substrate.

The present invention is directed to a process for coating articles in which the coating is catalytically cured using IR radiation, and to articles coated with the process of the invention. Articles that are coated with the process of the invention are preferably formed from plastic, glass, ceramic, or metal. Articles that may be coated with the process of the invention include, but are not limited to, containers, such as bottles, jars, cans, tubs, as well as trays for foods and beverages. Most preferably, the article is a thermoplastic preform for blow molding a container, but may also be a fully formed article, including, but not limited to, a plastic or glass bottle or jar or a metal can. The coating materials preferably comprise thermoplastic materials that provide at least one of good gas-barrier characteristics, UV protection, scuff resistance, blush resistance, chemical resistance, active properties for O₂ scavenging, and a reduced coefficient of friction.

The coating materials also comprise at least one coating catalyst, such as a transition metal or transition metal compound, that accelerates the curing of the coating material when exposed to IR radiation. Preferably, the transition metal is selected from the group consisting of cobalt, rhodium, and copper, where cobalt is most preferred. Transition metal compounds useful as catalysts in the invention include, but are not limited to carboxylates, such as neodecanoate, octoate, and acetate. The amount of catalyst used is, at least in part, determined by the nature of the catalyst. Preferably, for a cobalt neodecanoate catalyst, the catalyst is present in an amount of from about 20 to about 150 ppm by weight, more preferably, from about 50 to about 125 ppm by weight, and, most preferably, from about 75 to about 100 ppm by weight.

Radiation in the IR spectrum is typically considered to be that having a wavelength of from at least 0.7 μm (700 nm) to about 100 μm. Preferably, the IR radiation used to cure the coating has a wavelength of at least about 0.9 μm (900 nm), and, more preferably, at least about 1.0 μm.

Articles in accordance with the invention may further comprise an IR radiation-absorbing additive, such as carbon black, to enhance and improve the curing process. The additive may be incorporated into the coating composition and/or the substrate in any amount that increases absorption of IR radiation without discoloring the finished article. Where the substrate comprises a sufficient quantity of the IR radiation-absorbing additive, curing occurs outward from substrate/coating interface to the outer surface of the coating layer.

Plastic articles, as described herein, preferably comprise a PET substrate. However, the process of the invention is applicable to many other plastics, particularly, polyester thermoplastics. Other suitable plastic article substrates include, but are not limited to, polyesters, polyolefins, including polypropylene and polyethylene, polycarbonate, polyamides, including nylons, and acrylics. These substrate materials may be used alone or in conjunction with each other. More specific substrate examples include, but are not limited to, polyethylene 2,6- and 1,5-naphthalate (PEN), glycol-modified polyesters (“PETG”), polytetramethylene 1,2-dioxybenzoate and copolymers of ethylene terephthalate and ethylene isophthalate.

Glass articles may be made from water glass, soda-lime glass, lead glass, borosilicate glass, or any other type of glass known in the art. Metal articles include, but are not limited to, steel, galvanized steel, aluminum, and anodized aluminum.

One or more layers of a coating material may be applied with the process of the invention, and may comprise gas-barrier layers, UV protection layers, oxygen scavenging layers, carbon dioxide scavenging layers, and other layers as needed for a particular application. Preferably, the coating material is selected to adhere well to the article substrate.

For coating plastic containers, the coating is preferably applied to a preform that is then blown into a container in a blow mold. When possible, coating preforms, rather than a full-sized container, is advantageous in that preforms are smaller in size and have more regular shapes than fully formed containers. This makes it simpler to obtain an even and regular coating. Furthermore, bottles and containers of varying shapes and sizes can be made from preforms having a similar size and shape. Thus, the same equipment and processing can be used to coat preforms to form several different types of containers. The blow-molding may take place soon after molding and coating, or preforms may be made and stored for later blow-molding. If the preforms are stored prior to blow-molding, their smaller size allows them to take up less space in storage. Although coating a preform, and blow molding the coated preform is preferable to coating a finished plastic container, the methods of the present invention are clearly useful for coating fully molded plastic containers and other articles, including metal, ceramic, and glass articles, which, of course, are not made by blow molding preforms.

Difficulties that can arise during the blow-molding process include delamination of the layers, cracking or crazing of the coating, uneven coating thickness, and discontinuous coating or voids. Those difficulties are overcome with the present invention by using coating materials and methods that provide good adhesion between the layers of the finished preform and container. A preferred coating material sticks directly to the coated article without any significant delamination, and, with a coated preform, continues to stick as the preform is blow-molded into a container. Use of the preferred coating materials also decreases the incidence of cosmetic and structural defects that can result from blow-molding containers as described above.

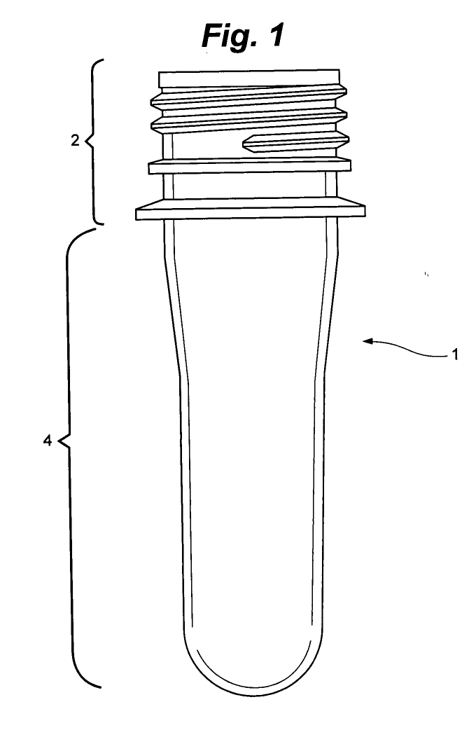

An uncoated preform 1 is illustrated in FIG. 1 as a non-limiting example of an article that can be coated with the invention. For use with beverages, preform 1 is preferably made of an FDA-approved material, such as virgin PET, and can have any of a wide variety of shapes and sizes. For example, for a 16 ounce carbonated beverage bottle, the preform 1 has a mass of about 24 grams. However, as will be understood by those skilled in the art, in addition to preforms, the articles of the invention includes other articles, having different configurations depending upon the desired configuration, characteristics, materials, and use of the article. Uncoated articles, such as the preform 1, may be made using any method known in the art. Thermoplastic articles are preferably formed by injection molding.

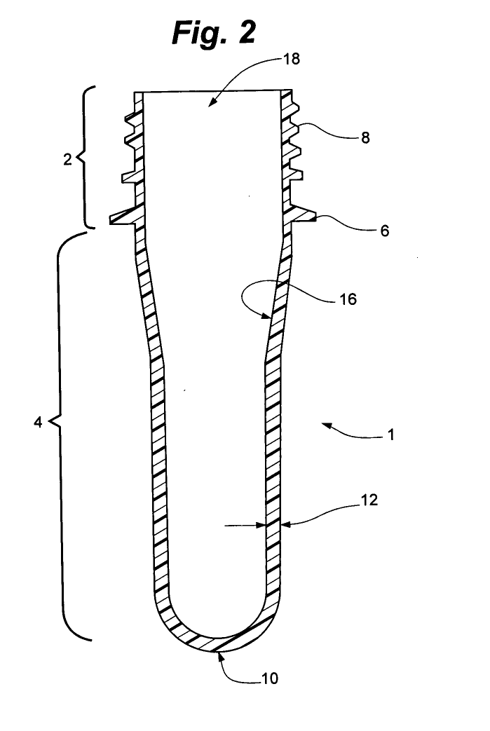

The preform 1 is illustrated in cross-section in FIG. 2. The uncoated preform 1 has a neck portion 2 and a body portion 4. The neck portion 2 begins at the opening 18 to the interior of the preform 1, and extends to and includes a support ring 6. The neck portion 2 is further characterized by the presence of the threads 8, which provide a way to fasten a cap. The body portion 4 is an elongated and cylindrically shaped structure extending down from the neck portion 2 and culminating in the rounded end cap 10. The thickness 12 of the preform 1 will depend upon the overall length of the preform 1 and the wall thickness and overall size of the resulting container.

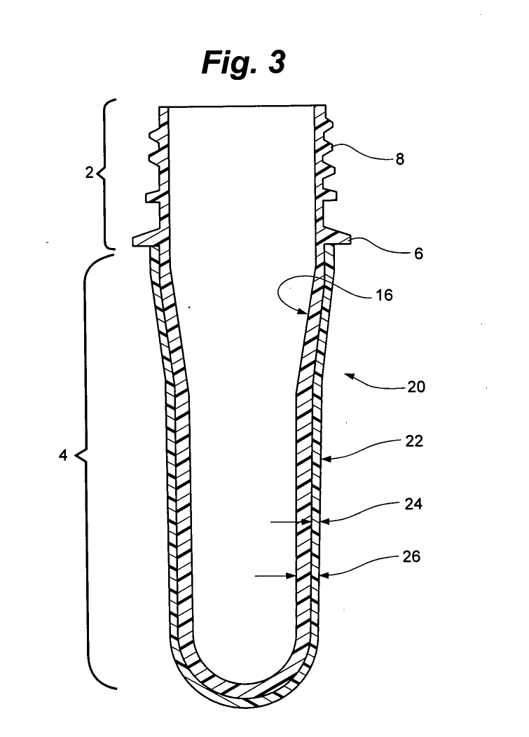

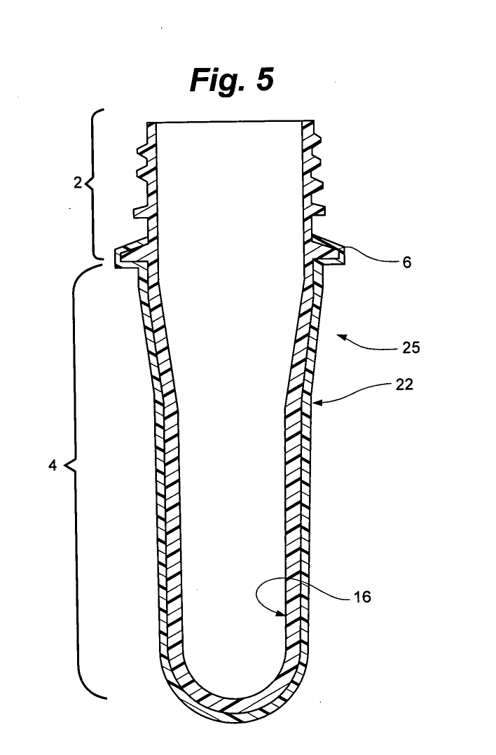

FIG. 3 is a cross-sectional illustration of a non-limiting example of a coated preform 20 in accordance with the present invention. As with the uncoated preform 1 in FIGS. 1 and 2, the coated preform 20 has a neck portion 2 and a body portion 4. A coating layer 22 is disposed about the entire surface of the body portion 4, terminating at the bottom of the support ring 6, and, as illustrated, neither extends to the neck portion 2, nor is present on the interior surface 16 of the preform, which, for containers for consumable foods and beverages, is preferably made of an FDA-approved material such as PET. The coating layer 22 may comprise one layer of a single material, one layer of several combined materials, or two or more layers each comprising at least one material, where the materials in the layers may be the same or different. The overall thickness 26 of the preform is equal to the thickness of the initial preform plus the thickness 24 of the coating layer or layers, and is dependent upon the overall size and desired coating thickness of the resulting container. The coating may also extend above the support ring, as illustrated in FIG. 5, which illustrates such a coated preform 25 in cross-section. The coated preform 25 differs from the coated preform 20 in FIG. 3 in that the coating layer 22 is disposed on the support ring 6 of the neck portion 2 as well as the body portion 4. Preferably, for a preform or container, any coating that is disposed on or above the support ring 6 is made of an FDA-approved material.

Coated preforms and containers in accordance with the invention may comprise layers having a wide range of relative thicknesses. The thickness of a given layer and of the overall preform or container, whether at a given point or over the entire container, is selected to meet the requirements of the particular coating process and end use for the article. As discussed above, the coating layer in the preform and container embodiments disclosed herein may comprise a single material, a layer of several materials combined, or several layers of at least two or more materials.

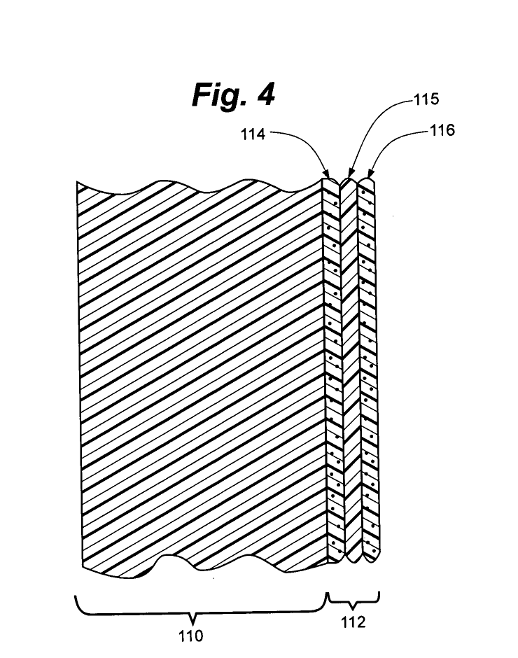

FIG. 4 illustrates a cross-section of a wall of a coated article in accordance with the invention, showing the substrate and coating layers. As illustrated, the substrate 110 of the article is coated with a plurality of layers 112 that form the outer portion of the article, where the layer 114 comprises the inner coating layer of coating material in contact with the substrate 110, the layer 115 comprises a middle layer of coating material, and the layer 116 comprises the outer layer of coating material. Any of layers 114, 115, and 116 may comprise one or more additional layers, and the layers may be the same or different. In accordance with the invention, at least one of the layers comprises a catalyst used to cure the layer in the presence of IR radiation.

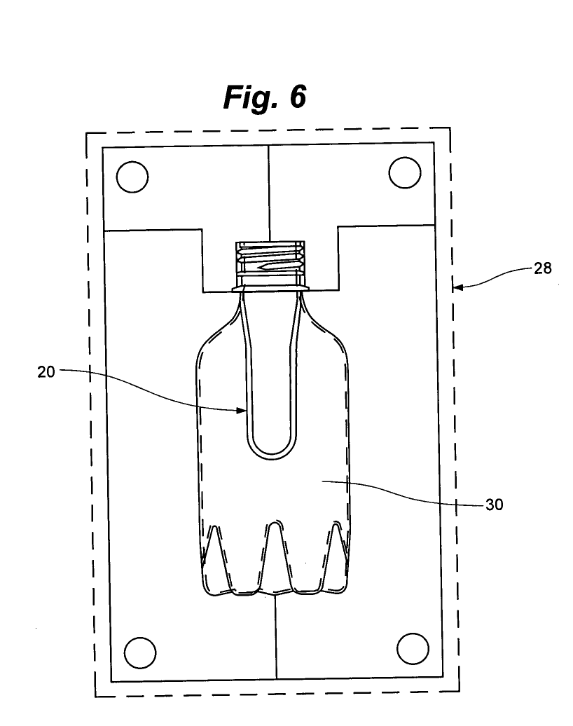

After coating, preferably using the method and apparatus discussed in detail below, a preform, such as those depicted in FIGS. 3 and 5, is converted into a container using a stretch blow-molding process. As illustrated in FIG. 6, this process comprises placing a coated preform 20 into a blow mold 28 with a cavity having the shape of desired container. The coated preform 20 is then heated and expanded by stretching and by forcing air into the interior of the preform 20 to fill the cavity within the mold 28, creating a coated container 30. The blow molding operation normally is restricted to the body portion 4 of the preform with the neck portion 2 including the threads, pilfer ring, and support ring retaining the original configuration as in the preform.

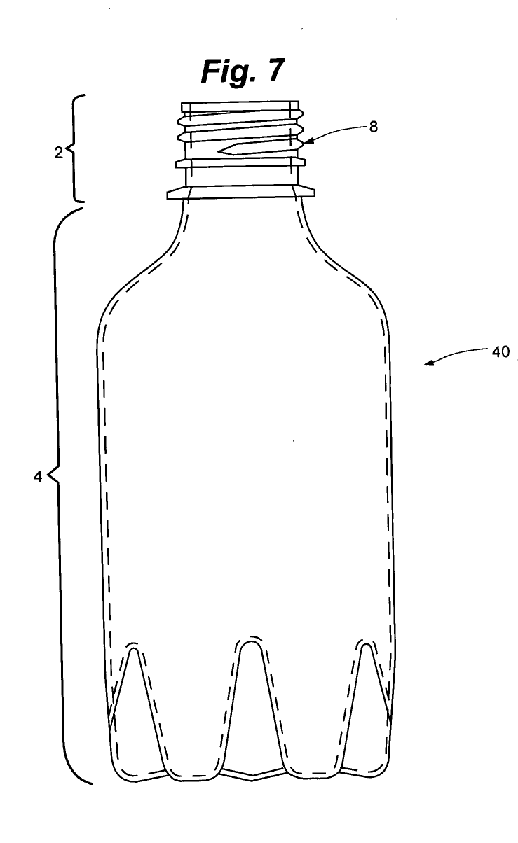

A bottle 40 in accordance with the invention is illustrated in FIG. 7. As illustrated, the bottle 40 may be of the type formed using a blow mold with a coated preform such as that illustrated in FIGS. 3 and 5, but may also be a container formed by any other method and material known in the art, coated with the method of the invention, and having any useful shape. The bottle 40 exemplifies coated containers in accordance with the invention. The bottle 40 has a neck portion 2 and a body portion 4 corresponding to the neck and body portions of the coated preform 20 of FIG. 3. The neck portion 2 is further characterized by the presence of the threads 8 which provide a way to fasten a cap onto the container.

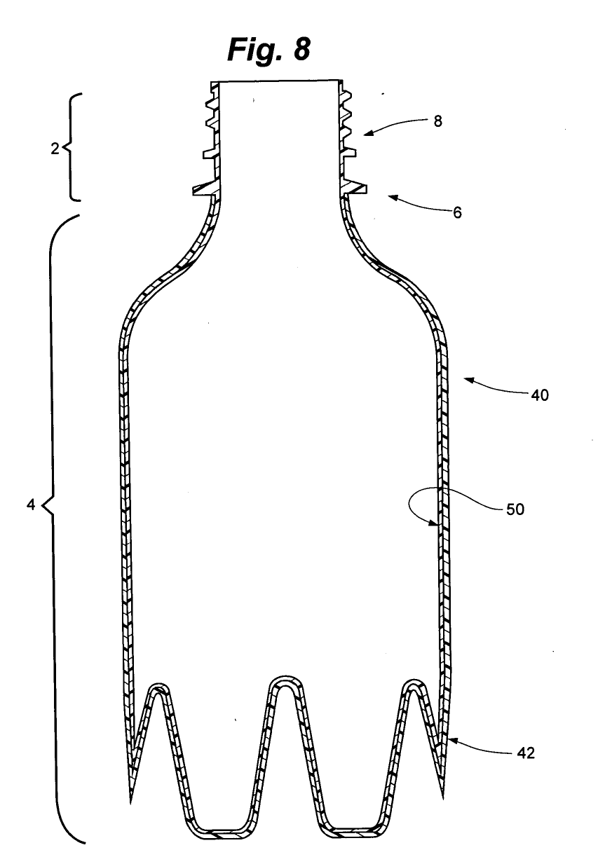

The cross-sectional view of the coated bottle 40, as illustrated in FIG. 8, shows the layered construction of a container of the invention. The coating 42 covers the exterior of the entire body portion 4 of the bottle 40, stopping just below the support ring 6. The interior surface 50 of the container, which is made of an FDA-approved material, preferably PET, remains uncoated so that only the interior surface 50 is in contact with beverages or foodstuffs. In a preferred embodiment for use as a carbonated beverage container, a 24 gram preform is blow molded into a 16 ounce bottle with a coating ranging from about 0.05 to about 0.75 grams.

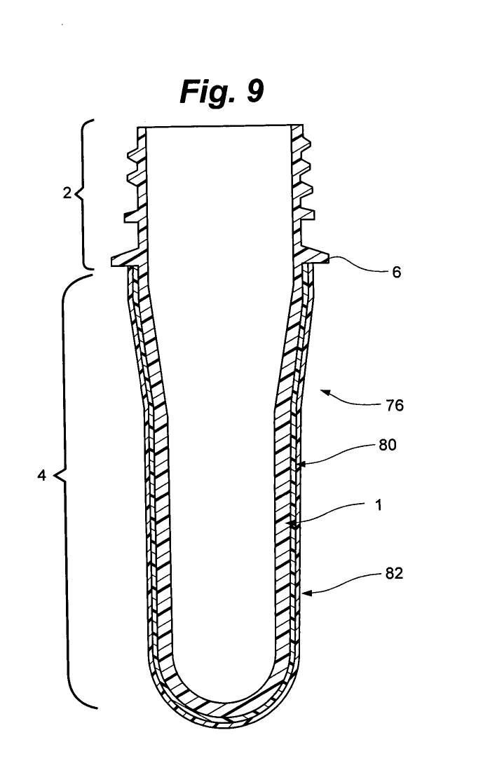

Referring to FIG. 9 there is shown a preferred three-layer preform 76. This embodiment of coated preform is preferably made by placing two coating layers 80 and 82 on a preform 1 such as that shown in FIG. 1.

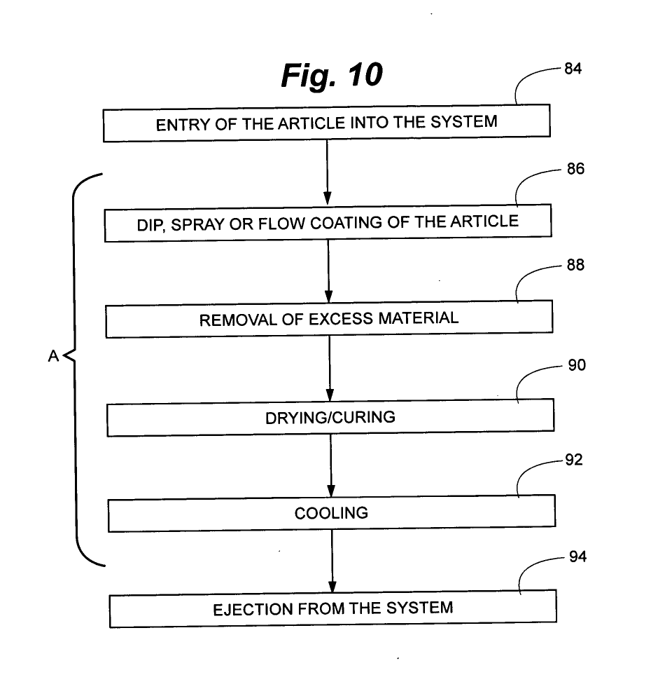

Referring to FIG. 10 there is shown a non-limiting flow diagram that illustrates a preferred process and apparatus. A preferred process and apparatus involves entry of the article into the system 84, dip, spray, or flow coating of the article 86, removal of excess material 88, catalyzed IR drying/curing 90, cooling 92, and ejection from the system 94.

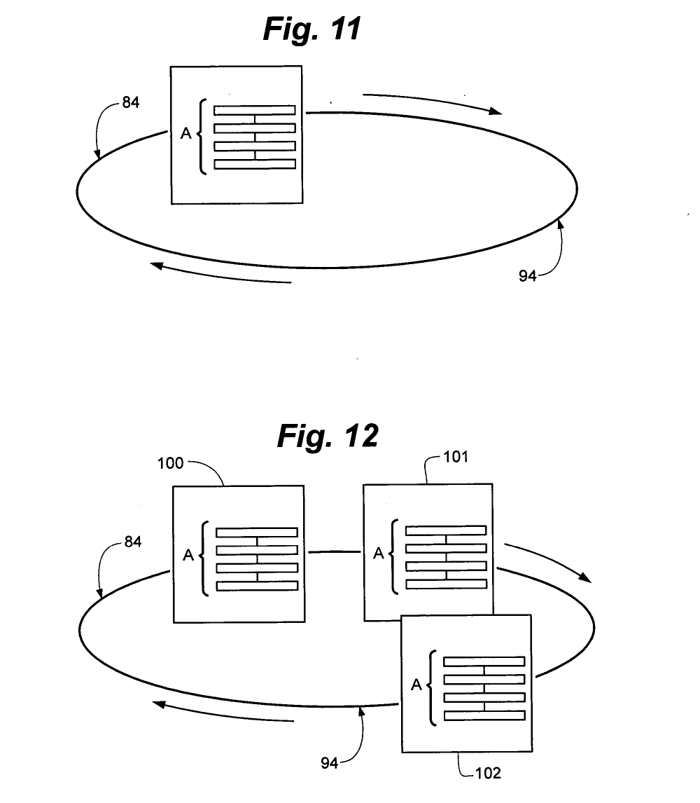

Referring to FIG. 11 there is shown a non-limiting flow diagram of one embodiment of the preferred process wherein the system comprises a single coating unit, A, of the type in FIG. 10 which produces a single coat article. The article enters the system at 84 prior to the coating unit and exits the system at 94 after leaving the coating unit in which the coating is catalytically cured using IR radiation.

Referring to FIG. 12 there is shown a non-limiting flow diagram of the preferred process wherein the system comprises a single, integrated processing line that contains multiple stations 100, 101, and 102 wherein each station coats and dries or cures the article thereby producing an article with multiple coatings. In at least one of the stations 100, 101, and 102, the coating material contains a curing catalyst, and the coating is catalytically cured using IR radiation. The article enters the system at 84 prior to the first coating unit 100 and exits the system at 94 after the last coating unit 102. The embodiment described herein illustrates a single integrated processing line with three coating units, it is to be understood that any practical number of coating units may be used.

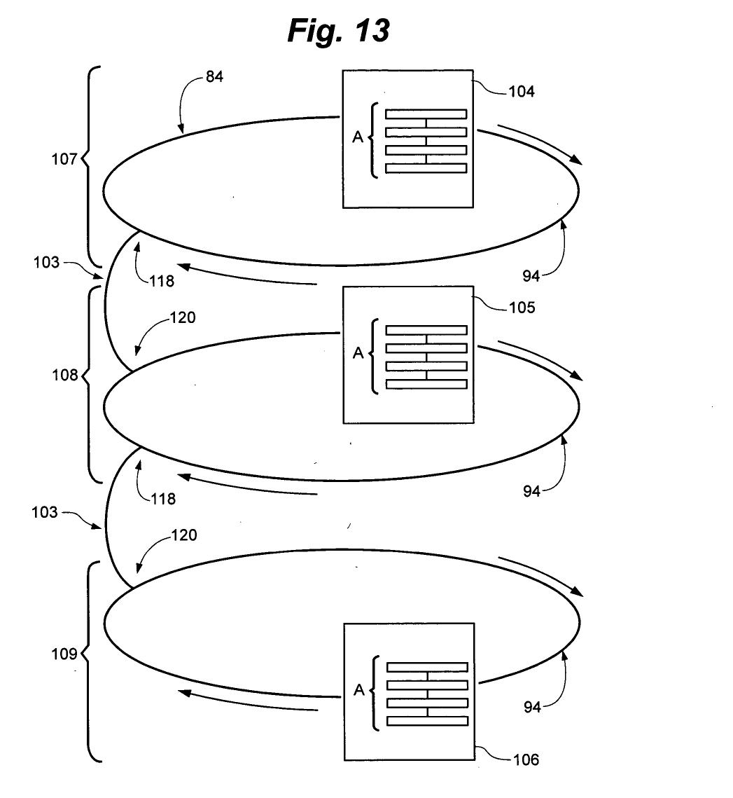

Referring to FIG. 13 there is shown a non-limiting flow diagram of one embodiment of the preferred process. In this embodiment, the system is modular wherein each processing line 107, 108, and 109 is self-contained with the ability to handoff to another line 103, thereby allowing for single or multiple coatings depending on how many modules are connected thereby allowing maximum flexibility. In at least one of the processing lines 107, 108, and 109, the coating material contains a curing catalyst, and the coating is catalytically cured using IR radiation. The article first enters the system at one of several points in the system at 84 or 120. The article can enter system at 84 and proceed through the first module 107, then the article may exit the system at 94 or exit the module at 118, and continue to the next module 108 through a hand off mechanism 103 known to those of skill in the art. The article then enters the next module at 120. The article may then continue on to the next module 109 or exit the system from any module 107, 108, 109 at 94. The number of modules may be varied depending on the production circumstances required. Further, the individual coating units 104, 105, and 106 may comprise different coating materials, at least one of which will contain an IR curing catalyst, depending on the requirements of a particular production line. The interchangeability of different modules and coating units provides maximum flexibility.

The preferred method and apparatus are described below with regard to making coated preforms. However, as will be recognized by those skilled in the art, the method of the invention may be used to coat cans, bottles, jars, and the like, or any other article that requires coating that does not degrade when exposed to coating compositions useful in the invention.

As will be understood by those skilled in the art, the chemical and physical properties and characteristics of any coating material must be compatible with the substrate to ensure proper adherence between the substrate and the coating layer. Where the properties and characteristics of the coating material are not compatible with the substrate, the layered article is likely to delaminate or, at best, discolor. The compatibility between the substrate and the coating material is particularly important for preforms that are expanded into containers using blow-molding techniques, such as those made from the most preferred material for preforms, PET, where the coating material must stretch with the preform as the preform expands in the blow mold. Those skilled in the art will understand that the present invention is not limited to PET, but is also useful with other substrate materials, such as glass, metal, and ceramics.

For PET preforms and other polymeric articles, the glass transition temperature (“T_{g}”) of the polymer relates to the transition of the polymer from a glassy form to a plastic form. Over a range of temperatures above the T_{g}, a polymeric material is soft enough to allow it to flow readily when subjected to an external force or pressure, but is not sufficiently soft to act as a flowing liquid, rather than as a pliable solid. For blow-molding, preforms are heated to such a temperature to allow the preform to be stretched and expanded in the blow-molding process. That is, the preform material is heated sufficient to become soft enough to flow under the force of the air blown into the preform to fit the mold, but is not so soft that it completely melts, breaks up, or becomes uneven in texture. As the coating material must stretch with the preform substrate during the blow-molding process, it is highly desirable to use a coating material having a T_{g} similar to that of the preform, as materials having similar glass transition temperatures, also have a similar temperature range over which they can be blow-molded. This allows the materials to be processed together without compromising the performance of either material or the finished article.

In the blow-molding process, a preform is heated to a temperature sufficiently above the T_{g} of the preform material to allow the preform to flow and fill the mold in which it is placed when air is forced into the interior of the preform. If the preform is not sufficiently heated, the preform material will be too hard to flow properly, and will crack, craze, or not expand sufficiently to fill the mold. Conversely, if the preform is further heated excessively above the T_{g}, the material will become so soft that it will not hold its shape or process properly.

Where a coating material has a T_{g} similar to that of the preform substrate material, the blowing temperature range of the coating material will be similar to that of the substrate. For example, for a PET preform coated with a coating material having a similar T_{g}, the blowing temperature for both materials will be within similar, overlapping temperature range. Where the T_{g} values for the coating material and the substrate are sufficiently dissimilar, it will be impossible to find a temperature at which both materials can be blow-molded. However, where the T_{g} of each of the coating material and the preform are sufficiently similar, the coated preform will behave as if it were made of a single piece of a homogeneous material during blow molding, expanding smoothly, and forming an aesthetically appealing container, having a uniform thickness and coating.

The glass transition temperature of PET occurs in a window of about 75° to 85° C., depending upon how the PET is processed. The T_{g} for the preferred coating materials used to coat PET using the invention preferably range from about 55° to about 140° C., more preferably, from about 90° to about 110° C., and may be at any temperature within the overall range, e.g., any of about 60°, 65°, 70°, 80°, 95°, 100°, 105°, 115°, 120° and 130° C.

Another factor having an impact on the performance of coated preforms during blow molding is crystallinity of the material. Preferably, the coating materials are substantially amorphous rather than crystalline, as amorphous materials are easier to form into bottles and containers by blow-molding than crystalline materials. Although PET exists as both a crystalline and an amorphous material, in the present invention it is highly preferred that the crystallinity of the PET be minimized. This, among other things, aids interlayer adhesion in the blow-molding process.

Preferred coating materials also have a tensile strength and creep resistance similar to the substrate material, and, thus, act as a structural component of the finished article, where creep resistance relates to the ability of a material to resist changing its shape in response to an applied force. For PET articles and articles formed from other materials, this allows the coating material to displace some of the substrate material without sacrificing strength and performance. Similarity in tensile strength between the substrate and the coating materials provides structural integrity to the article, and similarity in creep resistance helps the article to retain its shape.

For applications where optical clarity is of importance, the coating materials preferably have an index of refraction similar to that of the substrate material. When the refractive index of the substrate and the coating material are similar, the finished articles are optically clear, and, thus, aesthetically pleasing. This is particularly important in beverage containers, where clarity of the container is typically desirable. Where the refractive indices of two materials placed in contact are substantially dissimilar, the resulting laminate may have visual distortions and/or be cloudy or opaque, depending upon the difference in the refractive indices.

Using the designation nᵢ to indicate the refractive index for the substrate and nₒ to indicate the refractive index for the coating material, the ratio between the values nᵢ and nₒ is preferably from about 0.8 to about 1.3, more preferably, from about 1.0 to 1.2, and, most preferably, from about 1.0 to about 1.1. As will be recognized by those skilled in the art, for the ratio nᵢ/nₒ=1, the distortion due to refractive index will be at a minimum, because the two indices are identical. As the ratio progressively varies from 1, the distortion increases progressively.

Preferably, the coating materials, particularly for PET preforms, comprise thermoplastic epoxy resins (TPEs), and, more preferably, “phenoxy” resins, which are a subset of thermoplastic epoxy resins. Phenoxy resins, as that term is used herein, include a wide variety of materials including those discussed in International Patent Publication No. WO 99/20462, also published as U.S. Pat. No. 6,312,641. A preferred subset of phenoxy resins, and, thus, thermoplastic epoxy resins, are the hydroxy-phenoxyether polymers, of which polyhydroxyaminoether copolymers (PHAE) are particularly preferred. Useful materials are disclosed in U.S. Pat. Nos. 6,011,111, 5,834,078, 5,814,373, 5,464,924, and 5,275,853, and International Patent Publication Nos. WO 99/48962, WO 99/12995, WO 98/29491, and WO 98/14498.

Preferably, the thermoplastic epoxy resins used as coating materials in the present invention comprise one of the following types:
(1) hydroxy-functional poly(amide ethers) having repeating units represented by any one of the Formulae Ia, Ib, or Ic: 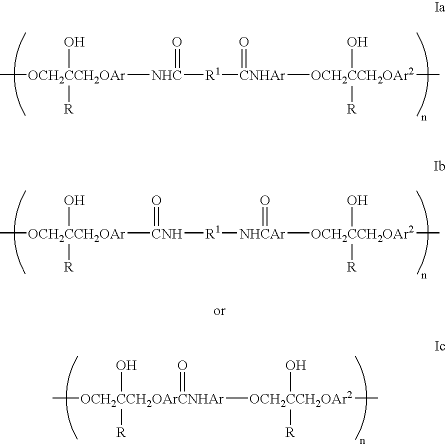
(2) poly(hydroxy amide ethers) having repeating units represented independently by any one of the Formulae IIa, IIb, or IIc: 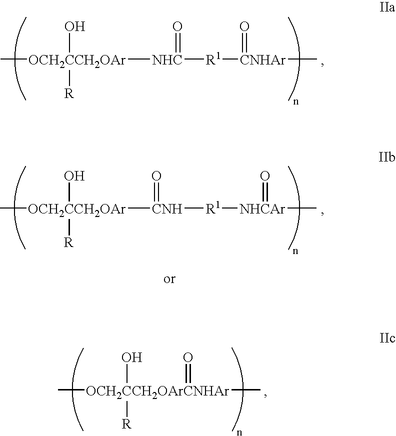
(3) amide- and hydroxymethyl-functionalized polyethers having repeating units represented by Formula III: 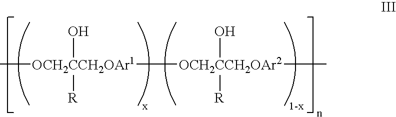
(4) hydroxy-functional polyethers having repeating units represented by Formula IV: 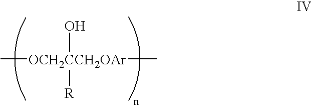
(5) hydroxy-functional poly(ether sulfonamides) having repeating units represented by Formulae Va or Vb: 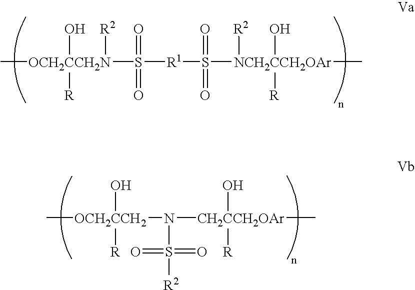
(6) poly(hydroxy ester ethers) having repeating units represented by Formula VI: 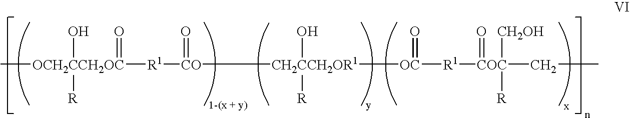
(7) hydroxy-phenoxyether polymers having repeating units represented by Formula VII: 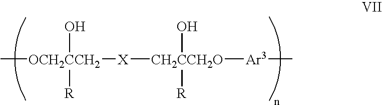
and
(8) poly(hydroxyamino ethers) having repeating units represented by Formula VIII: 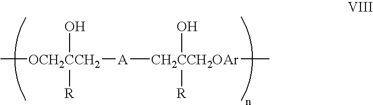
wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae: 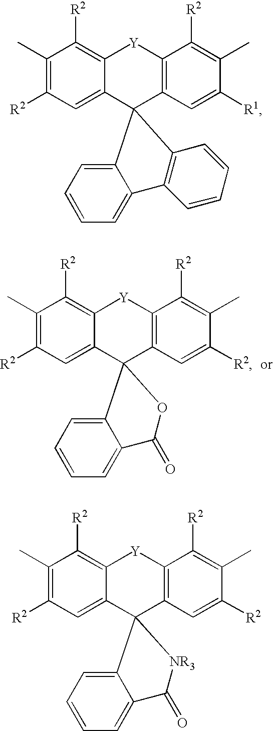
wherein Y is nil, a covalent bond, or a linking group, wherein suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

As used herein, the term “predominantly hydrocarbylene” refers to a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl) adipamide or N,N′-bis(3-hydroxyphenyl)glutaramide, with an epihalohydrin as described in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof.

The phenoxy thermoplastics commercially available from Phenoxy Associates, Inc. are suitable for use in the present invention. These hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. The process for preparing these is described in U.S. Pat. No. 3,305,528, incorporated herein by reference in its entirety.

Generally, preferred TPE, including phenoxy and PHAE, coating materials form stable aqueous-based solutions or dispersions. Preferably, the coating properties of the solutions/dispersions are not adversely affected by contact with water. Preferred coating materials range from about 10 percent solids to about 50 percent solids. Preferably, the coating material used dissolves or disperses in polar solvents. These polar solvents include, but are not limited to, water, alcohols, and glycol ethers.

One preferred thermoplastic epoxy coating material is a dispersion or solution of polyhydroxyaminoether copolymer (PHAE), represented by Formula VIII. The dispersion or solution, when applied to an article, greatly reduces the permeation rate of a variety of gases through the container walls in a predictable and well known manner. The dispersion or latex made thereof preferably contains 10 to 30 percent solids. A PHAE solution/dispersion may be prepared by stirring or otherwise agitating the PHAE in a solution of water with an acid, preferably acetic or phosphoric acid, but also including lactic, malic, citric, or glycolic acid and/or mixtures thereof. These PHAE solution/dispersions also include acid salts produced by the reaction of the polyhydroxyaminoethers with these acids.

The following PHAE polymers are preferred barrier materials for coating articles, particularly preforms and containers, that can be cured using a catalyst and IR radiation: PHAE materials comprising from about 10 to about 75 mole percent resorcinol copolymerized into the polymer chain, and dispersed in an aqueous medium using at least one of phosphoric acid, lactic acid, malic acid, citric acid, acetic acid, and glycolic acid. PHAE resins based on resorcinol have also provided superior results as a barrier material. Other variations of the polyhydroxyaminoether chemistry may prove useful such as crystalline versions based on hydroquinone diglycidylethers. Partially cross-linked PHAE materials exhibit high chemical resistance, low blushing and low surface tension. The solvents used to dissolve these materials include, but are not limited to, polar solvents such as alcohols, water, glycol ethers or blends thereof. Preferred cross-linkers are based on resorcinol diglycidyl ether (RDGE) and hexamethoxymethylmelamine (HMMM).

The preferred thermoplastic epoxies are soluble in aqueous acid. A polymer solution/dispersion may be prepared by stirring or otherwise agitating the thermoplastic epoxy in a solution of water with an acid, preferably acetic or phosphoric acid, but also including lactic, malic, citric, or glycolic acid and/or mixtures thereof. In a preferred embodiment, the acid concentration in the polymer solution/dispersion is preferably in the range of about 3 percent to 10 percent, more preferably about 4 percent to 6 percent by weight based on total weight. In other preferred embodiments, the acid concentration may be below about 3 percent or above about 10 percent depending on the type of polymer and type of acid and their molecular weights. The amount of dissolved polymer in a preferred embodiment ranges from about 20 percent to about 40 percent. A uniform and free flowing polymer solution is preferred.

Examples of preferred copolyester coating materials and a process for their preparation are described in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester coating materials are available from Mitsui Petrochemical Ind. Ltd. (Japan) as B-010, B-030 and others of this family.

The methods of the invention provide the flexibility of allowing the use of multiple functional additives to the coatings. Additives known by those of ordinary skill in the art include those that provide enhanced CO₂ barriers, O₂ barriers, UV protection, scuff resistance, blush resistance, impact resistance and/or chemical resistance. Useful additives need not be added to other coating layers, but, instead, may be used alone as a single coating layer.

Preferably, additives are not affected by the chemistry of the coating materials, are most preferably stable in aqueous solutions or suspensions, and may be included in coating compositions useful in the invention by any method known in the art. For example, useful additives may be mixed directly with a coating solution/dispersion, dissolved and/or dispersed separately from the coating solution/dispersion, and then added to a particular coating solution/dispersion, or combined with a particular coating prior to addition of the solvent that forms the solution/dispersion.

Examples of additives that may be used in the invention include materials that improve the ability of the coating to act as a gas barrier. For example, derivatives of resorcinol (m-dihydroxybenzene) may be used in conjunction with coating materials. The higher the resorcinol content, the greater the barrier properties of the coating. Another additive that may be used is nanoparticles or nanoparticular materials, which are tiny particles of materials that enhance the barrier properties of a material by creating a more tortuous path for migrating oxygen or carbon dioxide. One preferred type of nanoparticular material is a microparticular clay-based product available from Southern Clay Products, a division of Rockwood Specialties, Inc. of Princeton, N.J.

In a further embodiment, the UV protection provided by a coating material may be improved to provide protection at wavelengths less than about 400 nm. The UV protection material may be used as an additive in a particular layer, or applied separately in a separate coating. Preferably the UV protection material is added in a form that is compatible with aqueous-based solutions/dispersions.

Coatings that function as oxygen scavengers may also be provided using the present invention by providing a layer that reacts with or traps oxygen, such as anthroquinone. Again, as with other additives, certain oxygen scavengers may also be used alone as a separate coating. Oxygen scavenging materials are typically first activated by exposure to UV radiation, preferably prior to the drying/curing process.

Preferably, a top coat is applied to provide chemical resistance and/or abrasion resistance. Preferably these top coats are aqueous-based polyesters or acrylics which are optionally partially or fully cross-linked. A preferred aqueous-based polyester is polyethylene terephthalate, however other polyesters may also be used. A preferred aqueous-based polyester resin is described in U.S. Pat. No. 4,977,191 to Salsman, incorporated herein by reference, which discloses an aqueous-based polyester resin, comprising a reaction product of 20 to 50 percent by weight of waste terephthalate polymer, 10 to 40 percent by weight of at least one glycol and 5 to 25 percent by weight of at least one oxyalkylated polyol.

Another preferred aqueous-based polymer is a sulfonated aqueous-based polyester resin composition as described in U.S. Pat. No. 5,281,630 (Salsman), herein incorporated by reference, which discloses an aqueous suspension of a sulfonated water-soluble or water dispersible polyester resin comprising a reaction product of 20 to 50 percent by weight terephthalate polymer, 10 to 40 percent by weight of at least one glycol and 5 to 25 percent by weight of at least one oxyalkylated polyol to produce a prepolymer resin having hydroxyalkyl functionality where the prepolymer resin is further reacted with about 0.10 mole to about 0.50 mole of an α,β-ethylenically unsaturated dicarboxylic acid per 100 g of prepolymer resin and a thus produced resin, terminated by a residue of an alpha, beta-ethylenically unsaturated dicarboxylic acid, is reacted with about 0.5 mole to about 1.5 mole of a sulfite per mole of alpha, beta-ethylenically unsaturated dicarboxylic acid residue to produce a sulfonated-terminated resin.

Similarly, U.S. Pat. No. 5,726,277 to Salsman, incorporated herein by reference, discloses coating compositions comprising a reaction product of at least 50 percent by weight of waste terephthalate polymer and a mixture of glycols including an oxyalkylated polyol in the presence of a glycolysis catalyst, where the reaction product is further reacted with a di-functional, organic acid, and the weight ratio of acid to glycols in is the range of 6:1 to 1:2.

Other aqueous-based polymers are also suitable for use in the products and methods of the present invention. For example, suitable aqueous-based compositions are described in U.S. Pat. No. 4,104,222 to Date et al., incorporated herein by reference, which discloses a dispersion of a linear polyester resin obtained by mixing a linear polyester resin with a higher alcohol/ethylene oxide addition type surface-active agent, melting the mixture and dispersing the resulting melt by pouring it into an aqueous solution of an alkali under stirring. The dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70 to 95° C., where the alkanolamine is selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, and the alkanolamine is present in the aqueous solution in an amount of 0.2 to 5 weight percent, The surface-active agent of the higher alcohol/ethylene oxide addition type is an ethylene oxide addition product of a higher alcohol having an alkyl group of at least 8 carbon atoms, an alkyl-substituted phenol, or a sorbitan monoacylate, and the surface-active agent has an HLB value of at least 12.

Similarly, U.S. Pat. No. 4,528,321 to Allen discloses a dispersion in a water immiscible liquid of water soluble or water swellable polymer particles, made by reverse phase polymerization in the water immiscible liquid, which includes a non-ionic compound selected from C₄₋₁₂ alkylene glycol monoethers, their C₁₋₄ alkanoates, C₆₋₁₂ polyalkylene glycol monoethers, and their C₁₋₄ alkanoates.

The coating materials may be cross-linked to enhance thermal stability of coatings for hot fill applications. Inner layers may comprise low cross-linking materials while outer layers may comprise high cross-linking materials or other suitable combinations. For example, the inner coating on the PET surface may utilize non- or low cross-linked material, and the outer coat may utilize material capable of cross-linking to ensure maximum abrasion and chemical resistance.

The present invention provides the ability to handle many types of additives and coatings in an aqueous-based system, making the method of the invention easy and economical to use, compared to other systems. For example, as the present invention is aqueous-based, there is no need for expensive VOC handling equipment as is required in other systems, such as epoxy thermosets. In addition, most of the solvents can contact human skin without irritation, thereby allowing for ease of use in manufacturing.

Generally, preferred articles used herein are preforms with one or more coating layers, but may also include fully formed plastic, ceramic, glass, and metal articles. The coating layer provides additional functionality, such as gas-barrier protection, UV protection, impact resistance, scuff resistance, blush resistance, chemical resistance and the like. The coatings may be applied as multiple layers, where each layer has one or more functional characteristics, or in a single coating containing one or more functional components.

A preferred preform or container is a high-IPA PET preform or container, as described above. However, other suitable substrates may also be utilized depending on the particular circumstances. These other suitable article substrates include, but are not limited to, various ceramics, glasses, metals, and, for preforms in particular, polyesters and other polymers, such as polypropylene, polyethylene, polycarbonate, polyamides or acrylics.

For example, in one multiple coating process, the inner coating is a primer or base coat having functional properties for enhanced adhesion to PET, O₂ scavenging, UV resistance and/or as a passive gas-barrier, and the outer coatings provide passive barrier and scuff resistance. In other embodiments, multiple coated preforms comprise an inner coating layer that is an O₂ scavenger, an intermediate active UV protection layer, and an outer layer of a partially or highly cross-linked material. In a further embodiment, multiple coated preforms comprise an inner O₂ scavenger coating, an intermediate CO₂ scavenger coating, an intermediate active UV protection coating, and an outer coating of a partially or highly cross-linked material. Such combinations provide a hard, cross-linked coating suitable for carbonated beverages such as beer. In a further embodiment, useful for carbonated soft drinks, the inner coating layer is a UV protection covered by an outer layer of cross-linked material.

In yet a further embodiment, the final coating and drying of the preform provides scuff resistance to the surface of the preform and finished container in that the solution or dispersion contains diluted or suspended paraffin or wax, slipping agent, polysilane or low molecular weight polyethylene to reduce the surface tension of the container.

Once suitable coating materials having the desired properties are selected, the article is preferably coated in a manner that promotes adhesion between the two materials. Generally, adherence between coating materials and the substrate increases as the surface temperature of the article increases, and, thus, particularly for preforms, it is preferable to apply the coating on a heated article. However, it has been found that, for certain applications, the coating materials will adhere to the preform at room temperature.

Preforms in general, and PET preforms in particular, may become charged with static electricity that results in the preforms attracting dust and getting dirty quickly. Therefore, the preforms are preferably, but not necessarily, taken directly from the injection-molding machine, and coated while still warm. By coating the preforms immediately after they are removed from the injection-molding machine, not only is the dust problem avoided, it is believed that the warm preforms enhance the coating process. However, preforms that have been stored prior to coating may also be used. Preferably, such preforms are substantially clean, but cleaning need not be necessary.

Preferably, an automated system is used with the coating methods of the invention in which an article enters the system, is dip, spray, or flow coated, excess coating material is preferably removed, the coating material is dried and/or cured, where at least one layer of coating material contains a curing catalyst and is cured by exposure to IR radiation, the article is cooled, and finally ejected from the system. The apparatus useful in the invention may comprise a single integrated processing line, containing two or more dip, spray, and/or flow coating units and two or more curing/drying units, where at least one of the units cures the coating material by exposure to IR radiation to produce a preform having a plurality of coatings. In another embodiment, the system comprises one or more coating modules, each coating module comprising a self-contained processing line with one or more dip, spray, or flow coating units and one or more curing/drying units, where, again, at least one of the units cures the coating material by exposure to IR radiation. Depending on the module configuration, an article may receive one or more coatings, and, thus, one configuration may comprise three coating modules, where an article is transferred from one module to the next, and, in another configuration, the same three modules are utilized, but the article is transferred from the first to the third module, skipping the second. The ability to switch between different module configurations provides the maximum flexibility for providing coated articles. In a further preferred embodiment for coating articles, particularly preforms, either the modular or the integrated systems may be functionally associated with a production line for the articles to be coated, such as an injection-molding machine and/or a blow-molding machine.

A fully automated apparatus useful in the invention is described below. Although this non-limiting example of a useful system is described in terms of currently preferred materials, it will be understood by those skilled in the art that certain parameters will vary depending on the materials used and the particular physical structure of the desired end-product preform. As described, the apparatus and method are used to coat typical 24 gram preforms with a coating solution/dispersion at a suitable temperature and viscosity, depositing about 0.05 to about 0.75 grams of coating material per 24 gram preform. The preferred coating materials for preforms are TPEs, more preferably, phenoxy type resins, and, most preferably PHAEs, as described above. These materials and methods are described by way of example only, and are not intended to limit the scope of the invention in any way.

Articles, preferably preforms, are first brought into the system, typically, but not necessarily, without any alteration prior to entry into the system. For example, the system may be connected directly to a preform injection molding machine providing warm preforms to the system, or stored preforms may be introduced into the system by methods well known to those skilled in the art. Preferably, but not necessarily, stored preforms are first pre-heated to a temperature in a range of from about 38° C. to about 55° C., more preferably about 49° C., prior to entry into the system. Preferably, the stored preforms are clean, and, thus, cleaning is not necessary. Although, PET is the preferred material for preforms, other substrates may be used, such as various polymers such as polyesters, polyolefins, including polypropylene and polyethylene, polycarbonate, polyamides, including nylons, and acrylics, as well as metal, glass, and ceramic.

Once a suitable coating material is selected, it is prepared for use in at least one of dip, spray, and flow coating, but may be applied by any other useful method known in the art, such as by brushing. The coating may be prepared as a solution and/or dispersion comprising the coating material in one or more solvents for any of the coating methods.

As will be recognized by those skilled in the art, the temperature of the coating solution/dispersion can affect the viscosity of the solution/dispersion, such that, as the temperature is increased, the viscosity decreases, and vice versa. In addition, as viscosity increases, the rate of material deposition also increases. Therefore, the temperature can be used as a mechanism to control deposition. Preferably the solution/dispersion ranges from about 15° C. to about 27° C., and, more preferably, about 21° C. Above 27° C., certain solutions/dispersions may cure in the holding tank, and, below about 10° C., certain solutions/dispersions may be too viscous to use in dip, spray, or flow coating. Preferably, a temperature control system is used to ensure a constant temperature of the coating solution/dispersion. For certain coating materials, the addition of water may be used to decrease the viscosity of the solution/dispersion, and, thus, a water content monitor and/or a viscosity monitor may also be desirable.

In a preferred embodiment, the solution/dispersion is at a suitable temperature and viscosity to deposit about 0.05 to about 0.75 grams of coating material per 24 gram preform, and more preferably, about 0.15 to about 0.5 grams per 24 gram preform. However, any amount over that range may be used, including about 0.1, 0.2, 0.25, 0.3, 0.35, 0.4, 0.45, 0.55, 0.6, 0.65 and 0.70 grams per 24 gram preform.

Coated preforms produced from dip, spray, or flow coating are preferably of the type seen in FIG. 3. The coating 22 is disposed on the body portion 4 of the preform and does not coat the neck portion 2. The interior of the coated preform 16 is also preferably not coated. This may be accomplished through the use of a holding mechanism, comprising an expandable collet that is inserted into the preform combined with a housing surrounding the outside of the neck portion of the preform. The collet expands thereby holding the preform in place between the collet and the housing. The housing covers the outside of the neck including the threading, thereby protecting the inside of the preform as well as the neck portion from coating.

Coated preforms produced from dip, spray, or flow coating produce a finished product with substantially no distinction between layers. Further, the amount of coating material required to thoroughly coat the preform decreases with each successive layer.

In the dip coating process, the articles are dipped into a tank or other suitable container that contains the coating material. The dipping of the articles into the coating material may be accomplished with a retaining rack or the like, or by a fully automated process. Preferably, the preforms and other articles are rotated as they are dipped into the coating material. For a 1 inch diameter article, the container is preferably rotated at a speed of about 30 to 80 rpm, more preferably, about 40 rpm to about 70 rpm, and, most preferably, from about 50 to about 60 rpm. This allows for thorough coating of the container. As will be recognized by those of skill in the art, the speed of rotation is preferably slower for larger objects, as the circumference to the object, and, thus, the speed of the surface through the solution, suspension, and/or dispersion, is proportional to its diameter. For example, where the diameter is doubled, the rotational speed should be decreased by a factor of 2.

The article is preferably dipped for a period of time sufficient to allow for complete coverage. Generally, preferably this ranges from about 0.25 to about 5 seconds. Without wishing to be bound to any theory, it appears that a longer residence time does not provide any added coating benefit.

In determining the dipping time and therefore speed, the turbidity of the coating material should also be considered. If the speed is too high, the coating material may become wavelike and splatter causing coating defects. Another consideration is that many coating material solutions or dispersions form foam and/or bubbles which can interfere with the coating process. To avoid this interference, the dipping speed is preferably chosen to avoid excessive agitation of the coating material. If necessary anti-foam/bubble agents may be added to the coating solution/dispersion.

In the spray coating process, the articles are sprayed with a coating material that is in fluid connection with a tank or other suitable container that contains the coating material. The spraying of the articles with the coating material can be also be accomplished manually by the use of a retaining rack or the like, or it may be done by a fully automated process. Preferably, the articles are rotated during spraying, as described for dip coating, where the rate of rotation is substantially the same as that for dipping. Spray times are also substantially the same as dipping times, and, again, it appears that longer residence time does not provide any added coating benefit.

The properties of the coating material should be considered in determining the spraying time, nozzle size and configuration, and the like. If the spraying rate is too high, and/or the nozzle size incorrect, the coating material may splatter causing coating defects. If the speed is too slow, and/or the nozzle size incorrect, the resulting coating may be thicker than desired. As with dipping, foaming and/or bubbles can also interfere with the coating process, but may be avoided by selecting the spraying speed, nozzle, and fluid connections to avoid excessive agitation of the coating material. If necessary, anti-foam/bubble agents may be added to the coating solution, suspension, and/or dispersion.

In a flow coating process, a sheet of material, similar to a falling shower curtain or waterfall, through which the article passes for a thorough coating is preferably provided. Preferably, flow coating occurs with a short residence time of the article in the coating material. The article need only pass through the sheet for a period of time sufficient to coat the surface of the article. Again, a longer residence time does not provide any additional benefit for the coating. In order to provide an even coating, the article is preferably rotated while it proceeds through the sheet of coating material. Again, a 1 inch article is preferably rotated at a speed of about 30 to 80 rpm, more preferably, about 40 rpm to about 70 rpm, and, most preferably, from about 50 rpm to about 60 rpm, where the rotational speed for larger diameters is proportionally slower. More preferably the rotating article is placed at an angle while it proceeds through the coating material sheet. The angle of the article is preferably acute to the plane of the coating material sheet. This advantageously allows for thorough coating of the article without coating the neck portion or inside of the article.

The coating material is contained in a tank or other suitable container in fluid communication with the production line in a closed system, and is preferably recycled to prevent the waste of any unused coating material. This may be accomplished by returning the flow stream to the coating material tank, but should be done in a manner that avoids foaming and the formation of bubbles, which can interfere with the coating process. The coating material is preferably removed from the bottom or middle of the tank to prevent or reduce the foaming and bubbling. Additionally, it is preferable to decelerate the material flow prior to returning to the coating tank to further reduce foaming and/or bubbles. This can be done by means known to those of skill in the art. If necessary at least one anti-foaming agent may be added to the coating solution, suspension, and/or dispersion.

In choosing the proper flow rate of coating materials, several variables should be considered to provide proper sheeting, including flow rate velocity, length and diameter of the article, line speed and article spacing. The flow rate determines the accuracy of the sheet of material. If the flow rate is too fast or too slow, the material may not accurately coat the articles. When the flow rate is too fast, the material may splatter and overshoot the production line, causing incomplete coating of the article, waste of the coating material, and increased foaming and/or bubble problems. If the flow rate is too slow, the coating material may only partially coat the article.

The length and the diameter of the article to be coated should also be considered when choosing a flow rate. The sheet of material should thoroughly cover the entire article, therefore flow rate adjustments may be necessary when the length and diameter of articles are changed.

Another factor to consider is the spacing of the articles on the line. As the articles are run through the sheet of material a so-called wake effect may be observed. If the next article passes through the sheet in the wake of the prior article it may not receive a proper coating. Therefore it is important to monitor the speed and center line of the articles. The speed of the articles will depend upon the throughput of the specific equipment used.

Advantageously, the preferred methods provide a sufficiently efficient deposition of material that there is virtually no excess material that requires removal. However, in certain applications, it may be necessary to remove excess coating material after the article is coated by any of the dip, spray or flow methods. Preferably, the rotational speed and gravity will normalize the sheet on the article, and remove any excess material. If the holding tank for the coating material is positioned in a manner that allows the article to pass over the tank after coating, the rotation of the article and gravity should cause some excess material to drip off of the article back into the coating material tank. This allows the excess material to be recycled without any additional effort. If the tank is situated in a manner where the excess material does not drip back into the tank, other suitable means of catching the excess material and returning it to be reused may be employed.

Where the above methods are impractical due to production circumstances, various methods and apparatus known to those skilled in the art may be used to remove the excess material. For example, a wiper, brush, air knife or air flow may be used alone or in conjunction with each other. Further, any of these methods may be combined with the rotation and gravity method described above. Preferably any excess material removed by these methods is recycled for further use.

After the preform has been coated and any excess material removed, the coated preform is then dried and/or cured. At least one coating layer contains a curing catalyst, and is cured by exposure to IR radiation. Preferably, the drying and/or curing process for other coating layers not containing a catalyst is carried out by IR heating. Useful IR sources include, but are not limited to, 1000 W quartz IR lamps, such as a General Electric Q1500 T3/CL Quartzline Tungsten-Halogen lamp. IR sources may be purchased commercially from any of a number of sources, including General Electric and Phillips. The source may be used at full or reduced capacity, such as at about 50 percent, about 65 percent, about 75 percent, and the like. Lamps may be used alone or in combination at full or partial power. For example, six IR lamps have been used at 70 percent capacity. The use of infrared heating and/or curing, both catalytic and non-catalytic, allows a thermoplastic epoxy coating, such as a PHAE coating, to dry without overheating the substrate, and, for preforms, can be used to heat the substrate prior to blow molding, making for an energy efficient system. It has also been found that use of IR heating can reduce blushing and improve chemical resistance.

Although curing and/or drying may be performed without additional air, IR heating is preferably combined with forced air. The air used may be at any useful temperature. The combination of IR and air curing provides the unique attributes of superior chemical, blush, and scuff resistance of preferred embodiments. Further, without wishing to be bound to any particular theory, it is believed that the coating's chemical resistance is a function of cross-linking and curing. The more thorough the curing, the greater the chemical and scuff resistance.

In determining the length of time necessary to thoroughly dry and cure the coating, several factors, such as coating material, thickness of deposition, and article substrate should be considered. Different coating materials cure faster or slower than others. Additionally, as the degree of solids increases, the cure rate decreases. Generally, for articles with about 0.05 to about 0.75 grams of coating material, the curing time is about 10 to 120 seconds, although longer and shorter times may be required depending on the size of the article and the thickness of the coating.

An advantage of using a current of air in addition to IR heating is that the air regulates the surface temperature of the article, which provides flexibility in controlling the penetration of the radiant heat. If a particular embodiment requires a slower cure rate or a deeper IR penetration, this can be controlled with a current of air, the exposure time to the IR radiation, the IR lamp frequency, or a combination thereof.

Preferably, the article rotates while proceeding through the IR heater. Again, a 1 inch article is preferably rotated at a speed of about 30 to 80 rpm, more preferably, about 40 rpm to about 70 rpm, and, most preferably, from about 50 rpm to about 60 rpm, where the rotational speed for larger diameters is proportionally slower. If the rotation speed is too high, the coating will spatter causing uneven coating of the article. If the rotation speed is too low, the article will dry unevenly. Gas heaters, UV radiation, flame, and the like may be employed in addition to or in lieu of IR heating for those layers that are not catalytically cured.

The preform is then cooled in a process that acts with the curing process to provide enhanced chemical, blush and scuff resistance. This is believed to be due to the removal of solvents and volatiles after a single coating and between sequential coatings. Articles may be cooled in the cooling process at ambient temperature, or the cooling process may be accelerated by the use of forced ambient or cool air. During the cooling process, several factors must be considered, in particular for preforms. Preferably, the surface temperature of a coated preform is below the T_{g} of the both the T_{g} of the preform substrate and of the coating. For example, some coating materials have a lower T_{g} than the preform substrate material, in this example the preform should be cooled to a temperature below the T_{g} of the coating. Where the preform substrate has the lower T_{g}, the preform should be cooled below the T_{g} of the preform substrate.

The cooling time is also affected by the position in the process where the cooling occurs. Where multiple coatings are applied to each article, there is a cooling step prior to each subsequent coating, where cooling times may be reduced, as an elevated preform temperature is believed to enhance the coating process. Although cooling times vary, they are generally about 5 to 40 seconds for 24 gram preforms with about 0.05 to about 0.75 grams of coating material. It is also an important consideration that the forced air is maintained at a temperature sufficient to prevent undesirable shrinkage of the container, while maximizing removal of liquids prior to sealing the outer surface coating in the curing or drying step. An appropriate temperature of the forced air is important for preventing entrapment of liquid in the coating or between the coating and the substrate.

Once the container has cooled, it will be ejected from the system and prepared for packaging or handed off to another coating module, where a further coat or coats are applied before ejection from the system.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with the principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A process for making coated articles, the process comprising:
applying a first aqueous solution or dispersion of a thermoplastic resin on a surface of an article, wherein the first aqueous solution or dispersion comprises a thermoplastic epoxy resin and at least one IR coating catalyst to form a film;
exposing the film to IR radiation in an amount sufficient to at least partially cure the film; and
forming a substantially cured and/or dried thermoplastic epoxy coating.

2. The process according to claim 1, wherein the amount of IR radiation is at least sufficient to completely cure the film.

3. The process according to claim 1, wherein the application step further comprises applying the aqueous solution or dispersion by dip, spray, or flow coating.

4. The process according to claim 1, further comprising applying at least one additional coating to the article.

5. The process according to claim 1, further comprising applying at least one second aqueous solution or dispersion of a second thermoplastic resin on the article to form a second film, wherein the second aqueous solution or dispersion is the same as or different from the first aqueous solution or dispersion.

6. The process according to claim 5, wherein the application of the second aqueous solution or dispersion further comprises dip, spray, or flow coating.

7. The process according to claim 5, wherein the second aqueous solution or dispersion further comprises a thermoplastic epoxy resin and at least one IR curing catalyst to form a film; and the process further comprises exposing the film to IR radiation in an amount sufficient to at least partially cure the film.

8. The process according to claim 1, further comprising withdrawing the article from the dip, spray, or flow coating at a rate so as to form a coherent film, and removing any excess material resulting from the dip, spray, or flow coating.

9. The process according to claim 8, wherein the removal step further comprises the use of at least one of rotation, gravity, a wiper, a brush, an air knife, or air flow.

10. The process according to claim 1, further comprising cross-linking at least one coating layer to provide resistance to chemical or mechanical abuse.

11. The process according to claim 1, wherein the article comprises a substrate selected from the group of polymers consisting of polyesters, polyolefins, polycarbonates, polyamides and acrylics.

12. The process according to claim 11, wherein the substrate comprises amorphous and/or semi-crystalline polyethylene terephthalate.

13. The process according to claim 11, wherein the article is at least a portion of a preform.

14. The process according to claim 1, wherein the article comprises a substrate selected from the group consisting of glass, ceramic, and metal.

15. The process according to claim 1, further comprising curing and/or drying at least one coating layer using a drying/curing source selected from the group consisting of infrared heating, forced air, flame curing, gas heaters and UV radiation.

16. The process according to claim 15, further comprising maintaining the article at a temperature less than that at which the article melts or degrades.

17. The process according to claim 15, wherein the curing/drying source is infrared heating and forced air.

18. The process according to claim 17, further comprising maintaining the forced air at a temperature sufficient to prevent undesirable shrinkage of the article, while maximizing removal of liquids prior to sealing the outer surface of the article, thereby preventing entrapment of liquid in the coating.

19. The process according to claim 1, further comprising rotating the article as it is cured and/or dried.

20. The process according to claim 1, wherein the thermoplastic resin coating provides at least one of gas-barrier protection, UV protection, scuff resistance, blush resistance, and/or chemical resistance.

21. The process according to claim 1, wherein the thermoplastic epoxy resin further comprises at least one phenoxy resin.

22. The process according to claim 21, wherein the phenoxy resin further comprises at least one hydroxy-phenoxyether polymer.

23. The process according to claim 22, wherein the hydroxy-phenoxyether polymer further comprises at least one polyhydroxyaminoether copolymer.

24. The process according to claim 23, wherein the at least one polyhydroxyaminoether copolymer is polymerized from resorcinol diglycidyl ether, hydroquinone diglycidyl ether, bisphenol A diglycidyl ether, or mixtures thereof.

25. The process according to claim 24, wherein the solution or dispersion of the thermoplastic epoxy resin comprises at least one acid salt, formed from the reaction of at least one polyhydroxyaminoether with at least one of phosphoric acid, lactic acid, malic acid, citric acid, acetic acid, and glycolic acid.

26. The process according to claim 1, further comprising applying at least one coating of an acrylic, phenoxy, latex, or epoxy coating to the article, and cross-linking the coating.

27. The process according to claim 27, wherein the coating is cross-linked during drying and/or curing.

28. The process according to claim 1, wherein the IR coating catalyst is a transition metal or transition metal compound or complex.

29. The process according to claim 28, wherein the transition metal is selected from the group consisting of cobalt, rhodium, and copper.

30. The process according to claim 28, wherein the transition metal is cobalt.

31. The process according to claim 28, wherein the transition metal compound or complex is selected from the group consisting or carboxylates of cobalt, copper, and rhodium.

32. The process according to claim 1, wherein at least one of the article and the aqueous solution or dispersion further comprises an infrared radiation-absorbing additive.

33. A multilayer article, comprising a substrate and at least one layer comprising a thermoplastic material and an IR curing catalyst.

34. The multilayer article according to claim 33, wherein the IR curing catalyst is selected from the group consisting of transition metals and transition metal compounds and complexes.

35. The multilayer article according to claim 34, wherein the transition metal is selected from the group consisting of cobalt, rhodium, and copper.

36. The multilayer article according to claim 34, wherein the transition metal is cobalt.

37. The multilayer article according to claim 34, wherein the transition metal compound or complex is selected from the group consisting of carboxylates of cobalt, rhodium, and copper.

38. The multilayer article according to claim 33, wherein the IR curing catalyst is present in the layer in an amount of from about 20 to about 150 ppm, based on the weight of the layer.

39. The multilayer article according to claim 33, wherein the substrate is a glass, ceramic, metal, or thermoplastic material.

40. The multilayer article according to claim 39, wherein the thermoplastic material is selected from the group consisting of polyesters, polypropylene, polyethylene, polycarbonate, polyamides and acrylics.

41. The multilayer article according to claim 33, wherein the article is a container preform or bottle having a body portion and neck portion, wherein the coating is disposed substantially only on the body portion, and there is substantially no distinction between layers on the bottle or a container formed from the preform.

42. The multilayer article according to claim 41, having at least one inner layer and at least one outer layer on the substrate, wherein the outer layer comprises an amount of coating material that is less than that of the inner layer.

43. The multilayer article according to claim 41, wherein the preform has a substrate comprising amorphous or semi-crystalline polyethylene terephthalate.

44. A multilayer container preform or bottle having a body portion, end cap, and neck portion, the preform or bottle comprising:
a substrate comprising a thermoplastic material, selected from the group consisting of polyesters, polyolefins, polycarbonates, polyamides and acrylics; and
at least one layer comprising a thermoplastic resin coating material and an IR coating catalyst disposed on the substrate.

45. The multilayer container preform or bottle according to claim 44, wherein at least one layer provides at least one of gas-barrier protection, UV protection, scuff resistance, blush resistance, and chemical resistance.

46. The multilayer container preform or bottle according to claim 44, wherein at least one layer is disposed substantially only on the body portion of the preform or bottle.

47. The multilayer container preform or bottle according to claim 44, wherein at least one layer is an intermediate layer positioned between the substrate and an outer layer, the intermediate layer being at least one of an O₂ scavenger inner coating layer, a CO₂ scavenger intermediate layer, and an ultraviolet protection intermediate layer, wherein the outer layer is optionally at least partially cross-linked.

48. The multilayer container preform or bottle according to claim 44, wherein the substrate comprises amorphous or semi-crystalline polyethylene terephthalate.

49. The multilayer container preform or bottle according to claim 44, wherein at least one of the substrate and the coating material further comprises an infrared radiation-absorbing additive.

50. The multilayer container preform or bottle according to claim 49, wherein infrared radiation-absorbing additive comprises carbon black.
